(19) United States
(12) Patent Application Publication
(10) Pub. No.: US 2002/0152332 A1
(43) Pub. Date: Oct. 17, 2002

(54) Systems and methods for integrating information from a database in a handheld internet appliance into a web site

(76) Inventors: David K. Rensin, Tiburon, CA (US); John Miniati, Menlo Park, CA (US); George Williams, Palo Alto, CA (US); Joshua Flank, Santa Clara, CA (US)

Correspondence Address: FISH & NEAVE, 1251 AVENUE OF THE AMERICAS, 50TH FLOOR, NEW YORK, NY, 10020-1105, US

(21) Appl. No.: 09/834,379

(22) Filed: Apr. 13, 2001

(51) Int. Cl. G06F 7/00

(52) U.S. Cl. 709/330

(57) ABSTRACT

Systems and methods for transferring information from a local database in a handheld Internet appliance to a web site displayed on the handheld Internet appliance is provided. The systems and methods of the present invention consist of a software solution that enables users of handheld Internet appliances to automatically transfer information from local databases associated with local applications in the handheld Internet appliance to web sites containing on-line forms. A user interface is provided in the web site for enabling the user to automatically fill on-line forms with information stored in the handheld Internet appliance.

### FIELD OF THE INVENTION

This invention relates generally to systems and methods for accessing Internet information associated with a data record of a local handheld Internet appliance application. More specifically, the present invention provides systems and methods for integrating information from a database in a handheld Internet appliance into a web site.

### BACKGROUND OF THE INVENTION

The Internet and the World Wide Web (hereinafter “the web”) have revolutionized the ways in which information is disseminated and shared. At any given time, the Internet enables millions of users worldwide to simultaneously access a wide variety of information and engage in activities as diverse as shopping, playing games, financial trading, among others.

At present, users can access Internet information through various “Internet appliances”, which are electronic devices configured with an Internet access system. Internet appliances include, but are not limited to, microprocessor based devices such as personal and portable computers, and handheld appliances such as personal digital assistants and electronic organizers.

Typically, the information is accessed through a connection to a “web page”, a multimedia composition that may contain text, audio, graphics, imagery, video, and nearly any other type of content that may be experienced through use of a computer or other electronic device. A web page may also be interactive, and contain user selectable links that cause other web pages to be displayed, forms that may be used by the user to submit information requested in the web page, interactive executable code, or other elements through which the user may interact with web pages. A group of one or more interconnected and closely related web pages is referred to as a “web site”.

A web site has a particular address associated with it called a Uniform Resource Locator (“URL”). To view a particular web site, users input its corresponding URL on a “web browser window” displayed by “web browser software”, such as Internet Explorer, available from Microsoft Corporation, of Redmond, Wash. The web browser software runs on the user's Internet appliance and is responsible for fetching the information displayed on the web site from a “web server” using a transfer protocol such as the HyperText Transfer Protocol (“HTTP”).

While most of the traffic on the Internet is initiated from personal computers, the growing demand by mobile business users to have access to Internet information from anywhere in the world has led to the development of various Internet access technologies for handheld Internet appliances such as wireless telephones and personal digital assistants (“PDAs”). In particular, it has become increasingly popular to access information available in the Internet via PDAs, such as the Palm handheld devices manufactured by Palm, Inc., of Santa Clara, Calif., the Handspring Visor manufactured by Handspring, Inc., of Mountain View, Calif., and the HP Jornada manufactured by the Hewlett-Packard Company of Palo Alto, Calif.

A PDA provides computing and information storage and retrieval capabilities for personal or business use, often for keeping schedule calendars and address book information handy. Information is accessed by means of an electronically sensitive pad on which handwriting can be received. Currently available PDAs contain a number of useful local applications including an address book, a calendar, a memo pad, a calculator, and a to-do list, among others. Users are provided with a special pen called a stylus to write on the pad and “tap” on icons on the PDA screen corresponding to the PDA applications. In addition, PDA expansion slots may be used to enhance the PDA capabilities with a digital camera, a GPS receiver, a scanner, and other devices. Recently developed PDAs such as the PDA Phone manufactured by Samsung Electronics, Co., Ltd., of Seoul, South Korea, and the Kyocera QCP 6035 Smartphone manufactured by Kyocera Wireless Corp., of San Diego, Calif., combine the functionalities of a PDA and a wireless phone into a single handheld appliance.

The Internet is accessed on a PDA by means of a wireless modem and Internet access software. The wireless modem may either be internally integrated into the PDA such as in the case of the Palm VIIx, manufactured by Palm, Inc., or connected externally as an expansion module. External wireless modems include the Thinmodem manufactured by Card Access, Inc., of American Fork, Utah, and the various modems manufactured by Novatel Wireless, Inc., of San Diego, Calif. The Internet access software may consist of a microbrowser, which is a simpler version of a web browser with reduced graphic capabilities, and a variety of APIs (application program interfaces) and associated applications for formatting and displaying web pages on the PDA screen.

There are many advantages in being able to access the Internet with a PDA. The PDA is extremely mobile and can be utilized by business persons and consumers who are traveling or otherwise do not have access to a desktop computer. The PDA enables business persons and consumers to manage, share, and secure the information needed on a daily basis. A PDA user can access the Internet to read e-mails, search for a restaurant, obtain a map and driving directions, purchase airline tickets or shop, all without the need for a traditional, desktop computer.

However, accessing the Internet using a PDA has several drawbacks. First, it can be a very time consuming process, requiring users to work through many options in order to access the desired information. Many “taps” may be needed in order to browse the web and view other information stored in the PDA. Second, the wireless Internet connection may be unreliable, and the user may have to wait a significant amount of time to receive the requested information. Lastly, it can be extremely cumbersome for the user to enter the required information when completing on-line forms.

For instance, a user who wants to obtain driving directions to or from a given address saved in the PDA's address book is required to perform a number of steps, including: (1) starting the address book application to get the address; (2) quitting the address book application; (3) connecting to the web site that provides driving directions; (4) and manually entering the address into an on-line form available in the web site.

In order to make travel arrangements for meetings listed on the PDA's calendar, the user must first quit the calendar application before connecting to a web site for making travel reservations, and then manually enter the departure date, time, location and destination, as well as a return date and time. Similarly, a user who is using the PDA's address book to find an e-mail address before sending an e-mail must first get the e-mail address in the address book and quit the address book application before starting the e-mail application and manually entering the e-mail address in the address field of the e-mail.

Alternatively, the user may launch a web site directly from a local application as described in copending, U.S. application Ser. No. ______ (OS-003A). The user must still, however, manually enter the data records saved in the local application into the on-line forms of the requested web site. There are currently no mechanisms in place to integrate local data of a handheld Internet appliance into web sites browsed from the appliance. In short, it can be inordinately difficult and time consuming for the PDA user to enter data stored in a handheld Internet appliance into on-line forms.

In view of the foregoing drawbacks, it would be desirable to provide systems and methods for integrating information from a database in a handheld Internet appliance into a web site.

It further would be desirable to provide systems and methods for automatically filling on-line forms with data records saved in a local database of a handheld Internet appliance.

It still further would be desirable to provide systems and methods for automatically filling on-line forms with favorite and most frequently used data records prior to displaying the on-line forms in a handheld Internet appliance.

It also would be desirable to provide systems and methods for retrieving a data record from a local database in a handheld Internet appliance while filling out an on-line form of a web site displayed on the handheld Internet appliance.

### SUMMARY OF THE INVENTION

In view of the foregoing, it is an object of the present invention to provide systems and methods for integrating information from a database in a handheld Internet appliance into a web site.

It is another object of the present invention to provide systems and methods for automatically filling on-line forms with data records saved in a local database of a handheld Internet appliance.

It is a further object of the present invention to provide systems and methods for automatically filling on-line forms with favorite and most frequently used data records prior to displaying the on-line forms in a handheld Internet appliance.

It is also an object of the present invention to provide systems and methods for retrieving a data record from a local database in a handheld Internet appliance while filling out an on-line form of a web site displayed on the handheld Internet appliance.

These and other objects of the present invention are accomplished by providing systems and methods for integrating information from a database in a handheld Internet appliance into a web site. The systems and methods consist of a software solution that enables users of handheld Internet appliances to automatically fill out on-line forms on web sites without having to manually enter the information. The on-line forms may be filled with data records from a local database in the handheld Internet appliance containing the “favorites” or “most frequently used” data records. Alternatively, the user may select a data record from a database in the handheld Internet appliance using a user interface displayed on the web site for each field in the on-line form that needs to be filled out by the user. The user interface enables the user to fill a field in an on-line form with a data record using one or two taps.

In a preferred embodiment, the systems and methods of the present invention involve five main software components: (1) a web site API; (2) a software plug-in; (3) a user interface; (4) a favorites database; and (5) a database browser. The web site API is inserted into each web site containing an on-line form that may be filled by a user of the handheld Internet appliance. The API invokes the software plug-in that implements the functions required to fill an on-line form with data records from a local database in the handheld Internet appliance. The software plug-in also enables users to launch a web site directly from a local application as described in copending, U.S. application Ser. No. ______ (OS-003A). In addition, the software plug-in automatically saves items from a web site into a local application as described in copending, U.S. application Ser. No. ______ (OS-003C). A local application consists of any software application used in the handheld Internet appliance, such as PIM applications, a web browser, word processing applications, spreadsheet applications, among others.

In a preferred embodiment, the web site API is referred to as the OneTap™ API, the software plug-in is referred to as the OneTap™ software plug-in, the user interface is referred to as the OneTap™ user interface, the favorites database is referred to as the OneTap™ favorites database, and the database browser is referred to as the OneTap™ database browser.

A user interface is displayed for each field to be filled out in an on-line form. The user interface consists of one or more buttons that, when tapped, display a menu for getting a data record from a local database in the handheld Internet appliance. The menu lists items that may be selected by the user to fill the fields of an on-line form. For example, the menu may list the home and work phone numbers of the user, which are usually required to fill on-line forms of electronic commerce web sites. In addition, the menu contains an option for the user to get a data record from a local database in the handheld Internet appliance, and enables the user to edit a list of favorite or most frequently used data records inserted in on-line forms.

The list of favorite or most frequently used data records is saved in a local favorites database in the handheld Internet appliance. A database browser is provided to allow the user to easily view the data records stored in the various databases in the handheld Internet appliance.

Advantageously, the present invention enables users to automatically fill on-line forms with data records saved in a local database of a handheld Internet appliance. The present invention also enables the on-line forms to be filled with data records from a local database of a handheld Internet appliance prior to displaying the web site containing the on-line forms. The data records may be part of a favorites list containing the most frequently used records in filling out on-line forms.

In addition, the present invention enables users to retrieve a data record from a local database in a handheld Internet appliance while filling out an on-line form of a web site displayed on the handheld Internet appliance.

### BRIEF DESCRIPTION OF THE DRAWINGS

The foregoing and other objects of the present invention will be apparent upon consideration of the following detailed description, taken in conjunction with the accompanying drawings, in which like reference characters refer to like parts throughout, and in which:

FIG. 1 is a schematic view of the system and the network environment in which the present invention operates;

FIG. 2 is a schematic view of the software components of the present invention;

FIG. 3 is an illustrative view of the HTML source code of a web page containing the web site API;

FIG. 4 is an illustrative view of the HTML source code of FIG. 3 formatted for display on the handheld Internet appliance;

FIG. 5 is a flowchart for using the systems and methods of the present invention to automatically fill an on-line form of a web site with a data record saved in a local database of a handheld Internet appliance;

FIG. 6 is an illustrative view of a menu for selecting a data record to fill an on-line form;

FIG. 7 is a schematic view of a favorites database in accordance with the principles of the present invention; and

FIG. 8 is an illustrative view of a handheld Internet appliance screen displaying a web site with an on-line form containing buttons for allowing a user to fill out the on-line form.

### DETAILED DESCRIPTION OF THE INVENTION

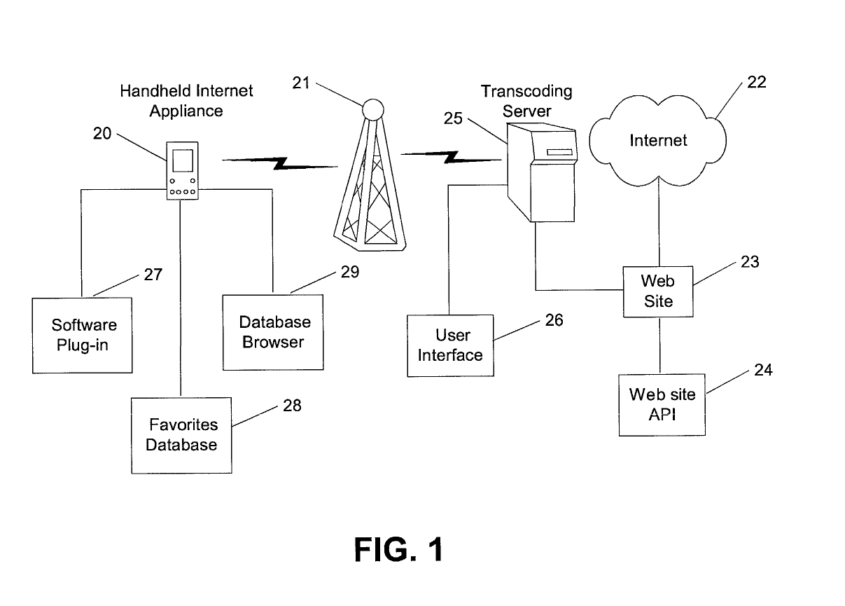

Referring to FIG. 1, a schematic view of the system and the network environment in which the present invention operates is described. Handheld Internet appliance 20 uses a wireless modem and Internet access software to connect to Internet 22 by means of a wireless network represented by base station 21. Handheld Internet appliance 20 may consist of a personal digital assistant (PDA) such as the Palm handheld devices manufactured by Palm, Inc., of Santa Clara, Calif., the Handspring Visor manufactured by Handspring, Inc., of Mountain View, Calif., and the HP Jornada manufactured by the Hewlett-Packard Company of Palo Alto, Calif. Handheld Internet appliance 20 may also consist of appliances having the functions of a PDA and a cellular phone, such as the PDA Phone manufactured by Samsung Electronics, Co., Ltd., of Seoul, South Korea, and the Kyocera QCP 6035 Smartphone manufactured by Kyocera Wireless Corp., of San Diego, Calif.

Handheld Internet appliance 20 has an electronically sensitive pad and screen on which handwriting can be received and visualized. Handheld Internet appliance 20 typically contains a number of useful local applications, which consist of any software application used in handheld Internet appliance 20, such as PIM applications including an address book, a calendar, a memo pad, a calculator, and a to-do list, a web browser application, a word processing application, a spreadsheet application, among others. Additional local applications such as games, spreadsheet programs, document processors, dictionaries, and others, may be easily added to handheld Internet appliance 20. Users are provided with a special pen called a stylus to write on the pad and “tap” on icons on the screen corresponding to the available applications. Handheld Internet appliance 20 has a main menu to display the application icons to the user. In addition, expansion slots may be used to enhance the capabilities of handheld Internet appliance 20 with a digital camera, a GPS receiver, a scanner, and other devices.

To protect the data saved in handheld Internet appliance 20, a synchronization technology may be used to synchronize the data from handheld Internet appliance 20 to a personal computer. Like a personal computer, handheld Internet appliance 20 has an operating system to manage its applications, input and output functions and devices, memory sharing, among other functions. Examples of currently available operating systems for handheld Internet appliance 20 include the Palm OS, developed by Palm, Inc., and the Windows CE, developed by Microsoft Corporation, of Redmond, Wash.

Handheld Internet appliance 20 connects to Internet 22 by means of a wireless modem. The wireless modem may be internally integrated into handheld Internet appliance 20 such as in the case of the Palm VIIx, manufactured by Palm, Inc., or connected externally as an expansion module. External wireless modems include the Thinmodem manufactured by Card Access, Inc., of American Fork, Utah, and the various modems manufactured by Novatel Wireless, Inc., of San Diego, Calif. In addition to the wireless modem, handheld Internet appliance 20 requires Internet access software to enable users to connect to the Internet. The Internet access software may consist of a microbrowser, which is a simpler version of a web browser with reduced graphic capabilities, and a variety of APIs (application program interfaces) and associated applications for formatting and displaying web pages on the PDA screen.

Handheld Internet appliance 20 has software plug-in 27 to implement the functions required to fill an on-line form with data records from a local database in the handheld Internet appliance. In addition, software plug-in 27 enables users to launch a web site directly from a local application as described in copending, U.S. application Ser. No. ______ (OS-003A), and automatically save items from a web site into a local application as described in copending, U.S. application Ser. No. ______ (OS-003C).

Handheld Internet appliance 20 contains a number of local databases corresponding to local applications to store the data records entered by the user. For instance, the address book application of handheld Internet appliance 20 has a local database associated with it to store the addresses in the address book, and the calendar application of handheld Internet appliance 20 has a local database associated with it to store the calendar items.

In addition to the local databases associated with local applications, handheld Internet appliance 20 has favorites database 28 to store the favorite or most frequently used data records in filling out on-line forms. For example, favorites database 28 may store the user's home and work phone numbers that are often required in on-line forms of electronic commerce web sites. Handheld Internet appliance 20 also has database browser 29 to enable users to quickly and easily view data records in local databases associated with local applications and in favorites database 28 for filling on-line forms.

Users of handheld Internet appliance 20 connect to Internet 22 to access e-mail and various web pages, such as web site 23, that are formatted for proper display on the screen of handheld Internet appliance 20. Web site API 24 is inserted into web site 23 for invoking software plug-in 27 in handheld Internet appliance 20. Web site API 24 is required for software plug-in 27 to fill on-line forms on web site 23 with data records from a local database in handheld Internet appliance 20. When a user requests web site 23 on handheld Internet appliance 20, transcoding server 25 checks web site 23 to verify the presence of web site API 24.

Transcoding server 25 also properly formats web site 23 for display by handheld Internet appliance 20. In addition, if web site API 24 is present on web site 23, transcoding server 25 inserts user interface 26 on web site 23 with links to software plug-in 27. User interface 26 consists of a button that, when tapped, displays a menu for getting a data record from a local database in handheld Internet appliance 20. The menu lists items that may be selected by the user to fill the fields of an on-line form in web site 23. For example, the menu may list the home and work phone numbers of the user, which are usually required to fill on-line forms of electronic commerce web sites. In addition, the menu contains an option for the user to get a data record from a local database in handheld Internet appliance 20, and enables the user to edit a list of favorite or most recently used data records inserted in on-line forms. Each item listed on the menu has a link to software plug-in 27 to properly fill an on-line form in web site 23 with data records from a local database in handheld Internet appliance 20.

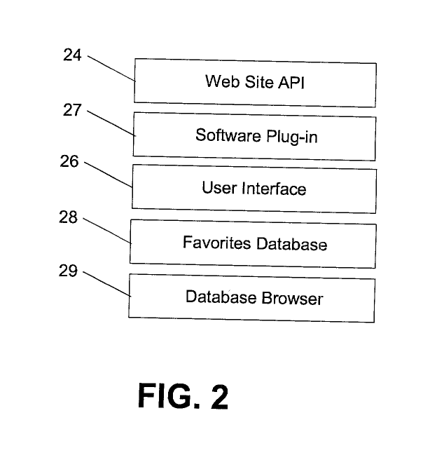

Referring now to FIG. 2, a schematic view of the software components of the present invention is described. The software components consist of: (1) web site API 24; (2) software plug-in 27; (3) user interface 26; (4) favorites database 28; and (5) database browser 29.

Web site API 24 is inserted into each web page containing an on-line form that may be filled by a user of handheld Internet appliance 20. Web site API 24 invokes software plug-in 27 to fill an on-line form with data records from a local database in handheld Internet appliance 20.

Software plug-in 27 implements the functions required to fill an on-line form with data records from a local database in handheld Internet appliance 20. Software plug-in 27 implements the following functions: (1) automatically fills on-line forms with data records saved in a local database of a handheld Internet appliance; (2) automatically fills on-line forms with favorite and most frequently used data records prior to displaying the on-line forms on handheld Internet appliance 20; and (3) retrieves a data record from a local database in handheld Internet appliance 20 to fill out an on-line form of a web site displayed on handheld Internet appliance 20. In addition, software plug-in 27 enables users to launch a web site directly from a local application as described in copending, U.S. application Ser. No. ______ (OS-003A), and automatically save items from a web site into a local application as described in copending, U.S. application Ser. No. ______ (OS-003C).

In a preferred embodiment, the web site API is referred to as the OneTap™ API, the software plug-in is referred to as the OneTap™ software plug-in, the user interface is referred to as the OneTap™ user interface, the favorites database is referred to as the OneTap™ favorites database, and the database browser is referred to as the OneTap™ database browser.

User interface 26 lists items that may be selected by the user to fill the fields of an on-line form. User interface 26 consists of one or more buttons that, when tapped, display a menu for getting a data record from a local database in handheld Internet appliance 20. For example, the menu may list the home and work phone numbers of the user, which are usually required to fill on-line forms of electronic commerce web sites. In addition, the menu contains an option for the user to get a data record from a local database in the handheld Internet appliance, and enables the user to edit a list of favorite or most recently used data records inserted in on-line forms.

Favorites database 28 stores a list of the favorite or most frequently used data records in filling out on-line forms. Database browser 29 is provided to allow the user to easily view the data records stored in the various databases in the handheld Internet appliance. For example, favorites database 28 may store the user's home and work phone numbers that are often required in on-line forms of electronic commerce web sites. Database browser 29 enables users to quickly and easily view data records in local databases associated with local applications and in favorites database 28.

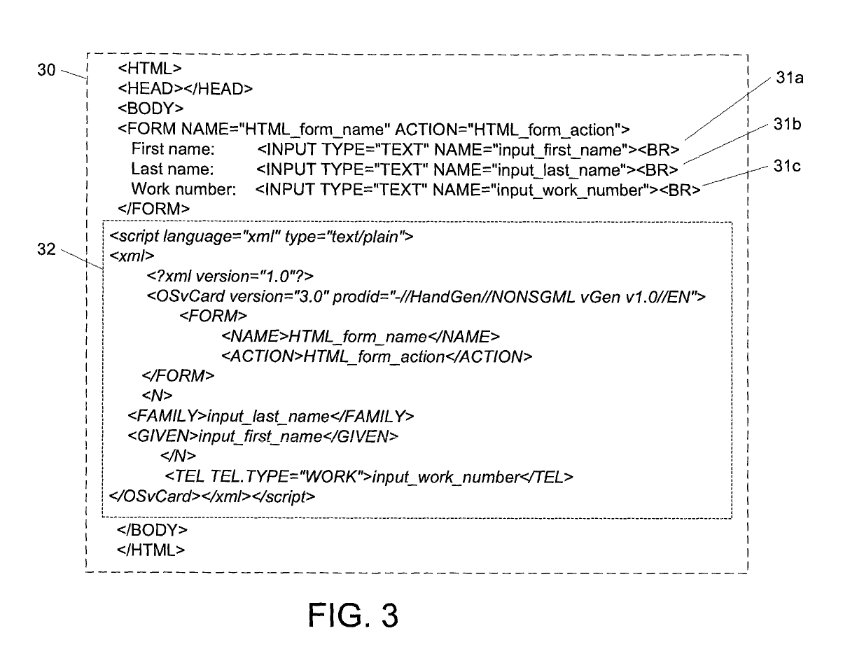

Referring now to FIG. 3, an illustrative view of the HTML source code of a web page containing the web site API is described. HTML source code 30 represents an on-line form containing fields 31a-c to be filled by a user. Field 31a is to be filled with the user's first name, field 31b is to be filled with the user's last name, and field 31c is to be filled with the user's work number. HMTL source code 30 also contains XML code 32 corresponding to web site web site API 24.

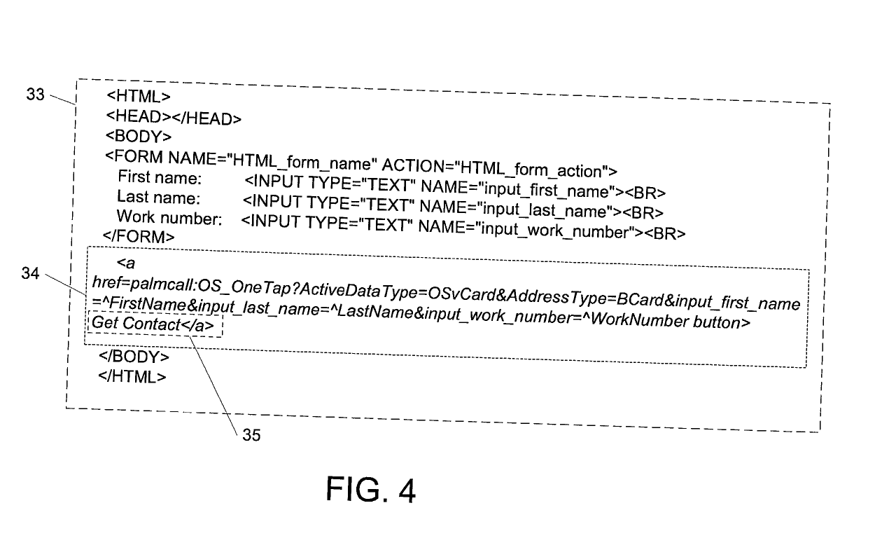

Referring now to FIG. 4, an illustrative view of the HTML source code of FIG. 3 formatted for display on the handheld Internet appliance is described. HTML code 33 is the formatted version of HTML code 30 of FIG. 3 for proper display on handheld Internet appliance 20. Upon encountering XML code 32 corresponding to web site API 24, transcoding server 25 formats HTML code 30 to replace XML code 32 with link 34. Link 34 is a link to the appropriate function of software plug-in 27 to get the user's first name, last name, and work number from a data record stored in a local database. In case handheld Internet appliance 20 is running the Palm OS, link 34 consists of a “palmcall”. Link 34 also contains user interface 35, represented by a “Get Contact” button. When tapped by the user, “Get Contact” button invokes database browser 29 to list the data entries stored in the local database corresponding to the address book application.

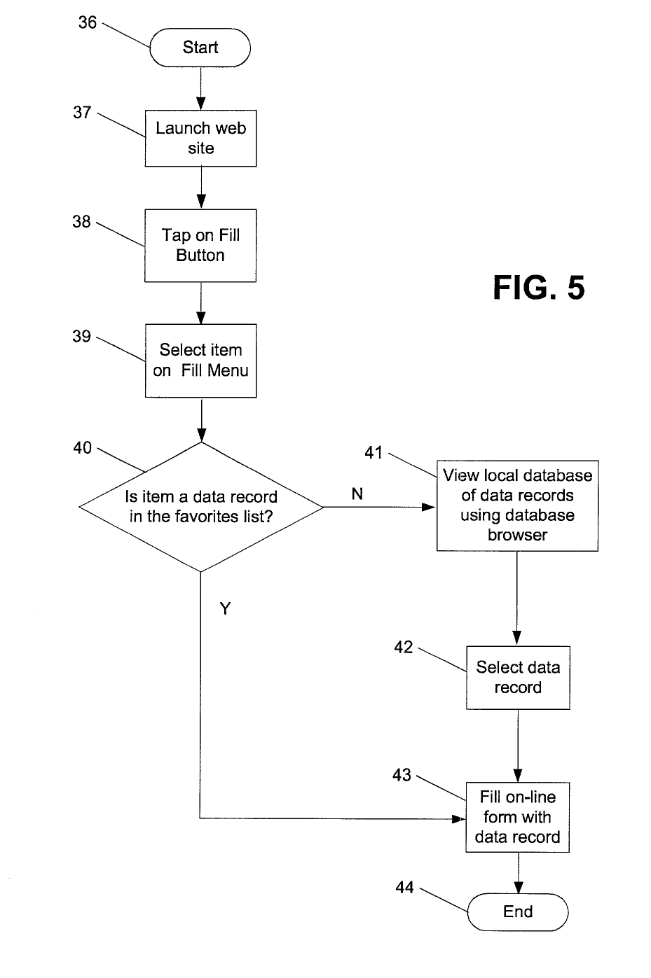

Referring now to FIG. 5, a flowchart for using the systems and methods of the present invention to automatically fill an on-line form of a web site with a data record saved in a local database of a handheld Internet appliance is described. At step 37, the user launches a web site containing on-line forms. The on-line forms may already be filled out with information associated with data records saved in favorites database 28. For example, if the user is accessing a web site for getting driving directions from his work address to a particular location, the on-line form corresponding to the starting address may already be filled with the user's work address if the user's work address is the most frequently used starting address in the web site. The user may then proceed to select a data record saved in a local database in the handheld Internet appliance to fill out the on-line form corresponding to the destination address.

At step 38, the user taps on the button displayed on the web site for selecting a data record to fill the on-line forms of the web site launched. When tapped, the button displays a menu containing items that may be selected by the user to fill the on-line forms. The items in the menu may be individual data records, or a request to get a data record in a local database of handheld Internet appliance 20. In addition, the menu has an option for clearing the on-line forms.

At step 39, the user selects an item on the menu. If the item is a data record (step 40), then the data record is automatically entered into the on-line form by software plug-in 27. Alternatively, if the item is not a data record but a request for a data record, the user views a local database of data records such as the database corresponding to the address book application (step 41) to select the data record to fill the on-line form (step 42). The selected data record is then entered into the on-line form at step 43. It should be understood by one skilled in the art that the user may perform steps 38-43 for each on-line form present in the web site.

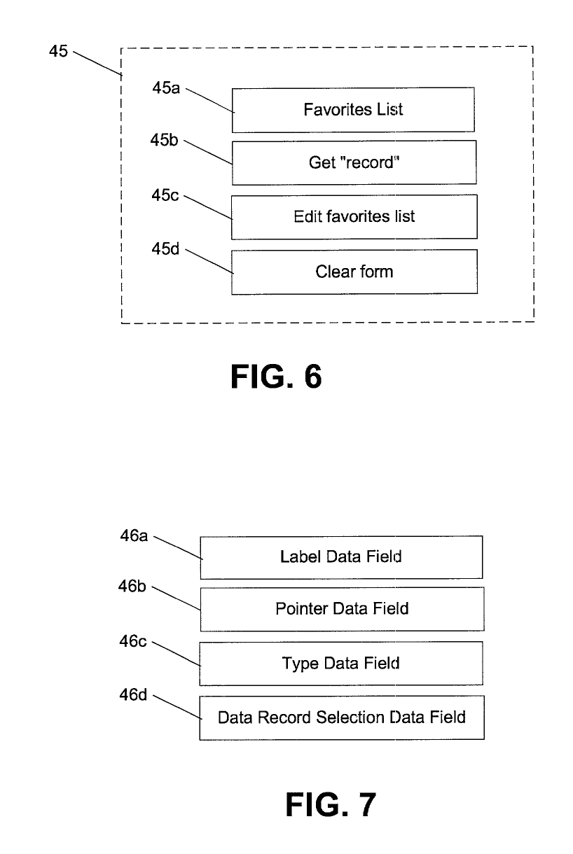

Referring now to FIG. 6, an illustrative view of a menu for selecting a data record to fill an on-line form is described. Menu 45 contains menu items 45a-d for filling out an on-line form with a data record saved into a local database of handheld Internet appliance 20. Menu items 45a-d vary according to the type of the field to be filled in the on-line form. For instance, a field may request a data record indicating a name, an address, a date, a credit card number, among others.

Menu item 45a consists of a list of favorite or most frequently used data records for a given field type. The favorite or most frequently used data records are stored in favorites database 28. In a preferred embodiment, the top three most frequently used data records are displayed to the user. Menu item 45b contains a “Get record” request. The type of data record requested depends on the particular field being filled out. For example, if the field type is an address, menu item 45b displays the message “Get address.” When menu item 45b is selected by the user, a local database containing the data records that may be entered into the given field of the on-line form is displayed to the user by means of database browser 29. For example, if the field type is an address, the local database associated with the address book application is displayed to the user.

Menu item 45c enables the user to edit the list of favorite or most frequently used data records for the particular field to be filled out on the on-line form. Menu item 45d enables the user to clear the contents of the fields on the on-line form.

Referring now to FIG. 7, a schematic view of a favorites database in accordance with the principles of the present invention is described. Favorites database 28 has data fields 46a-d corresponding to a favorite or most frequently used data record when filling out on-line forms. Data field 46a corresponds to a label displayed in the menu of user interface 26 for retrieving a particular data record. For example, the label may be “home” for the data record corresponding to the user's home address. Data field 46b is a pointer to a data record in a local database associated with a local application. For instance, in the case of an address, data field 46b is a pointer to the address saved in the local database associated with the address book application. Data field 46c lists the type of the data record to be entered into a given field in an on-line form. The type of the data record may be an address, date, name, among others. Data field 46d stores the data record selection in case more than one data record is allowed for a given label. For instance, the user may have more than one phone numbers listed for his home phone number.

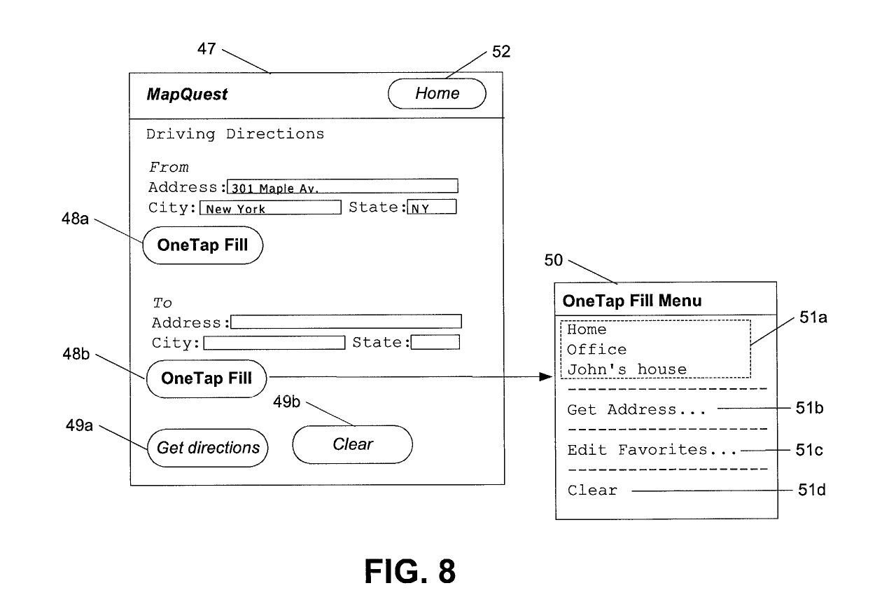

Referring now to FIG. 8, an illustrative view of a handheld Internet appliance screen displaying a web site with an on-line form containing buttons for allowing a user to fill out the on-line form is described. Handheld Internet appliance screen 47 is displaying the formatted www.mapquest.com web site belonging to America Online Time Warner, Inc., of Dulles, Va., for providing a user with driving directions. The web site contains an on-line form for the user to enter starting and destination addresses.

The web site has been properly formatted for screen 47. The web site contains API 24 for enabling software plug-in 27 to fill out the on-line form on the web site with data records stored in local databases in the handheld Internet appliance. In addition, the web site contains user interface 26, inserted in the web site by transcoding server 25, to enable the user to select the data records from local databases in the handheld Internet appliance to fill out the on-line form on the web site. User interface 26 is inserted in the web site in the form of buttons 48a-b.

Prior to displaying the web site on screen 47, software plug-in 27 fills out the starting address field in the on-line form with the most frequently used starting address. The most frequently used starting address is retrieved from favorites database 28. To fill out the field dedicated for the destination address in the on-line form, the user taps on button 48b. Menu 50 is then displayed on screen 47 to enable the user to select a destination address from local databases in the handheld Internet appliance.

Menu 50 contains menu items 51a-d to allow the user to select a destination address. Menu item 51a displays the top three frequently used addresses in filling out on-line forms. The top three addresses are labeled for easy recognition by the user, and are extracted from favorites database 28. Once menu item 51a is selected by the user, they are automatically entered into the destination address field of the on-line form by software plug-in 27.

Menu item 51b allows the user to get an address from the local database associated with the address book application of the handheld Internet appliance. Once menu item 51b is selected by the user, database browser 29 is activated on screen 47. Database browser 29 is displayed on screen 47 to allow the user to easily and quickly select an address from the local database associated with the address book application. The selected address is then automatically entered into the destination address field of the on-line form.

Menu item 51c allows the user to edit the list of favorite or most frequently used addresses, while menu item 51d allows the user to clear the destination address field of the on-line form. Alternatively, the user may clear the on-line form by tapping on button 49 provided by the web site.

Once the starting address and destination address fields are filled out, the user may tap on button 49 provided in the web site to display the desired driving directions. The user may return to the main menu of the handheld Internet appliance by tapping button 52 provided in the web site.

Although particular embodiments of the present invention have been described above in detail, it will be understood that this description is merely for purposes of illustration. Specific features of the invention are shown in some drawings and not in others, and this is for convenience only and any feature may be combined with another in accordance with the invention. Steps of the described processes may be reordered or combined, and other steps may be included. Further variations will be apparent to one skilled in the art in light of this disclosure and are intended to fall within the scope of the appended claims.

What is claimed is:

1. A method for transferring information from a local database in a handheld Internet appliance to a web site displayed on the handheld Internet appliance, the method comprising:
inserting a user interface in the web site for selecting a plurality of data records stored in the local database to fill a plurality of on-line forms in the web site;
providing a software plug-in to automatically fill the on-line form with a data record selected from the plurality of data records; and
inserting an application program interface in the web site for invoking the software plug-in.

2. The method of claim 1, further comprising
providing a database of favorite data records in the handheld Internet appliance to store a list of favorite and most frequently used data records by a user of the handheld Internet appliance; and
providing a database browser in the handheld Internet appliance to display the local database.

3. The method of claim 1, wherein the handheld Internet appliance comprises a wirelessly-enabled personal digital assistant.

4. The method of claim 3, wherein the handheld Internet appliance further comprises a plurality of local applications, the plurality of local applications comprising:
an address book application;
a calendar application;
an e-mail application;
a memo pad application;
a to-do list application;
a web browser application;
a word processing application; and
a spreadsheet application.

5. The method of claim 1, wherein the local database stores a plurality of data records representing information entered by the user when interacting with a local application in the handheld Internet appliance.

6. The method of claim 1, wherein inserting the user interface in the web site comprises inserting a plurality of buttons in the web site, each button from the plurality of buttons associated with a field of an on-line form from the plurality of on-line forms.

7. The method of claim 6, wherein each button from the plurality of buttons in the web site comprises a menu displaying menu items for selecting a data record to fill a field in the on-line form.

8. The method of claim 7, wherein the menu items comprise:
a list of favorite and most frequently used data records for filling the field in the on-line form;
a request for a data record from the local database;
an option for editing the list of favorite and most frequently used data records; and
an option for clearing the on-line form.

9. The method of claim 1, wherein the software plug-in comprises software routines for:
retrieving a data record from the local database or from the database of favorite data records;
inserting the data record in the on-line form;
creating the menu items associated with a field in the on-line form;
updating the menu items; and
clearing the on-line form.

10. The method of claim 9, wherein the software plug-in further comprises software routines for:
automatically launching a second local application from an already open first local application in the handheld Internet appliance;
automatically launching a web site from the first or second local application; and
automatically saving information from the web site into a database associated with the first or second local application.

11. The method of claim 1, wherein the database of favorite data records comprises a plurality of data fields and a plurality of data records, the data fields comprising:
a data record label data field;
a data record pointer data field;
a data record type data field; and
a data record selection data field.

12. The method of claim 11, wherein the label data field comprises a label displayed in the menu for selecting a data record to fill a field in the on-line form.

13. The method of claim 11, wherein the pointer data field comprises a pointer to a data record in a local database for retrieving the data record from the local database to fill a field on the on-line form.

14. The method of claim 11, wherein the type data field comprises the type of a data record to be retrieved from the local database to fill a field on the on-line form.

15. The method of claim 11, wherein the record selection data field comprises the record name to be retrieved in case the label in the label data field is used to represent more than one data record.

16. A system for transferring information from a local database in a handheld Internet appliance to a web site displayed on the handheld Internet appliance, the system comprising:
a user interface in the web site for selecting a plurality of data records stored in the local database to fill a plurality of on-line forms in the web site;
a software plug-in for automatically filling the plurality of on-line forms with a data record selected from the plurality of data records;
an application program interface in the web site for invoking the software plug-in;
a database of favorite data records in the handheld Internet appliance to store a list of favorite and most frequently used data records by a user of the handheld Internet appliance; and
a database browser in the handheld Internet appliance to display the local database.

17. The system of claim 16, wherein the handheld Internet appliance comprises a wirelessly equipped personal digital assistant.

18. The system of claim 17, wherein the handheld Internet appliance further comprises a plurality of local applications, the plurality of local applications comprising:
an address book application;
a calendar application;
an e-mail application;
a memo pad application;
a to-do list application;
a web browser application;
a word processing application; and
a spreadsheet application.

19. The system of claim 16, wherein the local database stores a plurality of data records representing information entered by the user when interacting with a local application in the handheld Internet appliance.

20. The system of claim 16, wherein the user interface in the web site comprises a plurality of buttons in the web site, each button from the plurality of buttons associated with a field of an on-line form from the plurality of on-line forms.

21. The system of claim 20, wherein each button from the plurality of buttons in the web site comprises a menu displaying menu items for selecting a data record to fill a field in the on-line form.

22. The system of claim 21, wherein the menu items comprise:
a list of favorite and most frequently used data records for filling the field in the on-line form;
a request for a data record from the local database;
an option for editing the list of favorite and most frequently used data records; and
an option for clearing the on-line form.

23. The system of claim 16, wherein the software plug-in comprises software routines for:
retrieving a data record from the local database or from the database of favorite data records;
inserting the data record in the on-line form;
creating the menu items associated with a field in the on-line form;
updating the menu items; and
clearing the on-line form.

24. The system of claim 23, wherein the software plug-in further comprises software routines for:
automatically launching a second local application from an already open first local application in the handheld Internet appliance;
automatically launching a web site from the first or second local application; and
automatically saving information from the web site into a database associated with the first or second local application.

25. The system of claim 16, wherein the database of favorite data records comprises a plurality of data fields and a plurality of data records, the data fields comprising:
a data record label data field;
a data record pointer data field;
a data record type data field; and
a data record selection data field.

26. The system of claim 25, wherein the label data field comprises a label displayed in the menu for selecting a data record to fill a field in the on-line form.

27. The system of claim 25, wherein the pointer data field comprises a pointer to a data record in a local database for retrieving the data record from the local database to fill a field on the on-line form.

28. The system of claim 25, wherein the type data field comprises the type of a data record to be retrieved from the local database to fill a field on the on-line form.

29. The system of claim 25, wherein the record selection data field comprises the record name to be retrieved in case the label in the label data field is used to represent more than one data record.

30. A handheld Internet appliance comprising a plurality of software components for transferring information from a local database in the handheld Internet appliance to a web site having a plurality of on-line forms displayed on the handheld Internet appliance, the software components comprising:
a software plug-in for automatically filling the plurality of on-line forms with a data record selected from the plurality of data records;
a database of favorite data records in the handheld Internet appliance to store a list of favorite and most frequently used data records by a user of the handheld Internet appliance; and
a database browser in the handheld Internet appliance to display the local database.

31. The handheld Internet appliance of claim 30, wherein the handheld Internet appliance comprises a wirelessly equipped personal digital assistant.

32. The handheld Internet appliance of claim 31, wherein the handheld Internet appliance further comprises a plurality of local, the plurality of local applications comprising:
an address book application;
a calendar application;
an e-mail application;
a memo pad application;
a to-do list application;
a web browser application;
a word processing application; and
a spreadsheet application.

33. The handheld Internet appliance of claim 30, wherein the local database stores a plurality of data records representing information entered by the user when interacting with a local application in the handheld Internet appliance.

34. The handheld Internet appliance of claim 30, wherein the web site comprises:
a user interface for selecting a plurality of data records stored in the local database to fill the plurality of on-line forms in the web site; and
an application program interface in the web site for invoking the software plug-in.

35. The handheld Internet appliance of claim 30, wherein the software plug-in comprises software routines for:
retrieving a data record from the local database or from the database of favorite data records;
inserting the data record in the on-line form;
creating the menu items associated with a field in the on-line form;
updating the menu items; and
clearing the on-line form.

36. The handheld Internet appliance of claim 35, wherein the software plug-in further comprises software routines for:
automatically launching a second local application from an already open first local application in the handheld Internet appliance;
automatically launching a web site from the first or second local application; and
automatically saving information from the web site into a database associated with the first or second local application.

37. The handheld Internet appliance of claim 30, wherein the database of favorite data records comprises a plurality of data fields and a plurality of data records, the data fields comprising:
a data record label data field;
a data record pointer data field;
a data record type data field; and
a data record selection data field.

38. The handheld Internet appliance of claim 37, wherein the label data field comprises a label displayed in the menu for selecting a data record to fill a field in the on-line form.

39. The handheld Internet appliance of claim 37, wherein the pointer data field comprises a pointer to a data record in a local database for retrieving the data record from the local database to fill a field on the on-line form.

40. The handheld Internet appliance of claim 37, wherein the type data field comprises the type of a data record to be retrieved from the local database to fill a field on the on-line form.

41. The handheld Internet appliance of claim 37, wherein the record selection data field comprises the record name to be retrieved in case the label in the label data field is used to represent more than one data record.

42. The handheld Internet appliance of claim 30, wherein the user interface in the web site comprises a plurality of buttons in the web site, each button from the plurality of buttons associated with a field of an on-line form from the plurality of on-line forms.

43. The handheld Internet appliance of claim 42, wherein each button from the plurality of buttons in the web site comprises a menu displaying menu items for selecting a data record to fill a field in the on-line form.

44. The handheld Internet appliance of claim 43, wherein the menu items comprise:
a list of favorite and most frequently used data records for filling the field in the on-line form;
a request for a data record from the local database;
an option for editing the list of favorite and most frequently used data records; and
an option for clearing the on-line form.
